(19) United States
(12) Patent Application Publication
(10) Pub. No.: US 2014/0349248 A1
(43) Pub. Date: Nov. 27, 2014

(54) PROGRAMMABLE DENTAL DEVICE

(71) Applicants: Gary J. Pond, Racine, WI (US); Wesley Day, Oak Creek, WI (US)

(72) Inventors: Gary J. Pond, Racine, WI (US); Wesley Day, Oak Creek, WI (US)

(21) Appl. No.: 14/457,487

(22) Filed: Aug. 12, 2014

Related U.S. Application Data
(63) Continuation of application No. 12/387,194, filed on Apr. 29, 2009.

(51) Int. Cl. A61C 1/00; A61C 17/14; A61C 17/20; A61C 17/02

(52) U.S. Cl. CPC A61C 1/0015; A61C 1/0092; A61C 17/0217; A61C 17/14; A61C 1/0069; A61C 17/20
USPC 433/86; 433/80

(57) ABSTRACT

A multiuse programmable dental device that allows the user to selectively program various fluid delivery regimens and methods of using and programming the irrigator device. The irrigator may also be operated manually, as desired by the operator. Other features, such as selective delivery of various fluids, monitoring fluids levels of the system, and the capability to store previously used regimens within the systems memory, are found in the present invention.

### RELATED APPLICATION

This application is a continuation of U.S. application Ser. No. 12/387,194, filed Apr. 29, 2009, now pending, which is incorporated by reference herein in its entirety.

### BACKGROUND OF THE INVENTION

The present invention relates to dental devices and equipment and more specifically to devices for irrigating and treating root canals and other dental surfaces that have the programmable capabilities.

Care is taken when performing dental procedures to optimize the procedure and, also, to insure that the proper solutions and irrigants are used during the procedure. For example, when performing endodontic treatments, care needs to be taken to adequately prepare the root canal for the treatment or procedure. The root canal should be thoroughly debrided of the infected pulp tissue to remove and reduce the number of pathogenic organisms within the root canal and, also, to properly shape the root canal.

Therefore, when properly debriding a root canal, clinicians and dental personnel must spend a relatively long period of time properly irrigating the root canal. Because of the time requirement, combined with imposed time limitations when carrying out dental procedures or dental regimens, clinicians may not always spend the requisite time needed to properly irrigate the root canal. Furthermore, there is no standard irrigation procedure for a regimen. This can lead to uneven treatment of root canals between patients. Also, the endodontic scientific literature is lacking in providing standard, consistent root canal irrigation methods.

Improvements have been made to regulate endodontic irrigation procedures. For example, Pond, U.S. Pat. No. 6,419,485, describes a useful device that allows the user to use multiple solutions for irrigation purposes.

The device provides a more consistent system for irrigating a root canal. Still, the device is contingent on how a user formats the device and not necessarily on what is proper for a specific tooth procedure.

### SUMMARY OF THE INVENTION

The present invention provides a multiuse programmable dental device that allows the user to selectively program various fluid delivery regimens and methods of using the dental device. The device may also be operated manually, as desired by the operator. Other features, such as selective delivery of various fluids, monitoring fluids levels of the system, and the capability to store previously used regimens within the systems memory, are found in the present invention. Monitoring the fluids may also include control of the temperature of the fluids within the system.

Generally speaking, the invention comprises a housing, having a plurality of fluid reservoirs attached to the housing. The fluid reservoirs are in selective communication with one or more dental instruments attached to the housing. A programmable logic controller (PLC) is located on the housing, with connections to the various pumps, valves, sensors, and other elements of the irrigator device. However, it is also possible to replace the PLC with a microcontroller.

The device also has a unique pumping and fluid control system that provides a compact routing system for the various fluids and electrical controls of the overall system. The fluid control system has a compact arrangement, wherein pumps, a motor or motors, and a circuit board are located close to one another to provide an efficient control system.

The present invention also contemplates methods of programming and providing various fluid delivery regimens for dental and medicinal procedures. The programming system provides the user various programming improvements, such as touch screen capability and audio feedback from the system to the user. The programming capabilities allow for the system to recognize various dental instruments that will be used in connection with the system, along with providing ultrasonic energy when necessary to an attached dental tool.

The device is capable of running more than one program or regimen concurrently, with the program employing one or more instruments.

The invention further provides a system that can be used to interact and connect with other operating systems.

### BRIEF DESCRIPTION OF THE DRAWINGS

FIG. 1 provides a perspective view of a programmable dental device according to the present invention.

FIG. 1A provides a perspective view of an alternate arrangement of a programmable dental device.

FIG. 2 provides a front partial perspective view of the dental device of FIG. 1 showing possible dental tools attached to the device.

FIG. 2A provides a front partial perspective view of the dental device as shown in FIG. 2, with an individual dental tool being attached to various fluid ports of the dental device.

FIG. 3 provides a partial exploded planar elevation view of a housing and fluid reservoirs used in the present invention.

FIG. 4 is a schematic flow diagram for the dental device of the present invention.

FIG. 5 is a perspective view of a programmable control device for use in the present invention, which includes an interactive control screen for a user to program the present invention.

FIG. 6 is a second perspective view of the control device of FIG. 5, showing various connection features for the control device.

FIG. 7 is a perspective view of the pumping control system of the present invention.

FIG. 8 is a perspective view of a pumping arrangement used in the pumping control system shown in FIG. 7.

FIG. 9 depicts a fluid routing panel used with the pumping control system shown in FIG. 7.

FIG. 10 is a front perspective view of the pumping arrangement of FIG. 8, showing the motor control arrangement being connected to various fluid tubings.

FIG. 10A is an overhead view of a pumping arrangement for the present invention.

FIG. 11 is a perspective view of a motor and housing used in conjunction with the pumping control system of FIG. 7.

FIGS. 12-22 present various programmable screens associated with the dental device, used to carry out various functions for the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

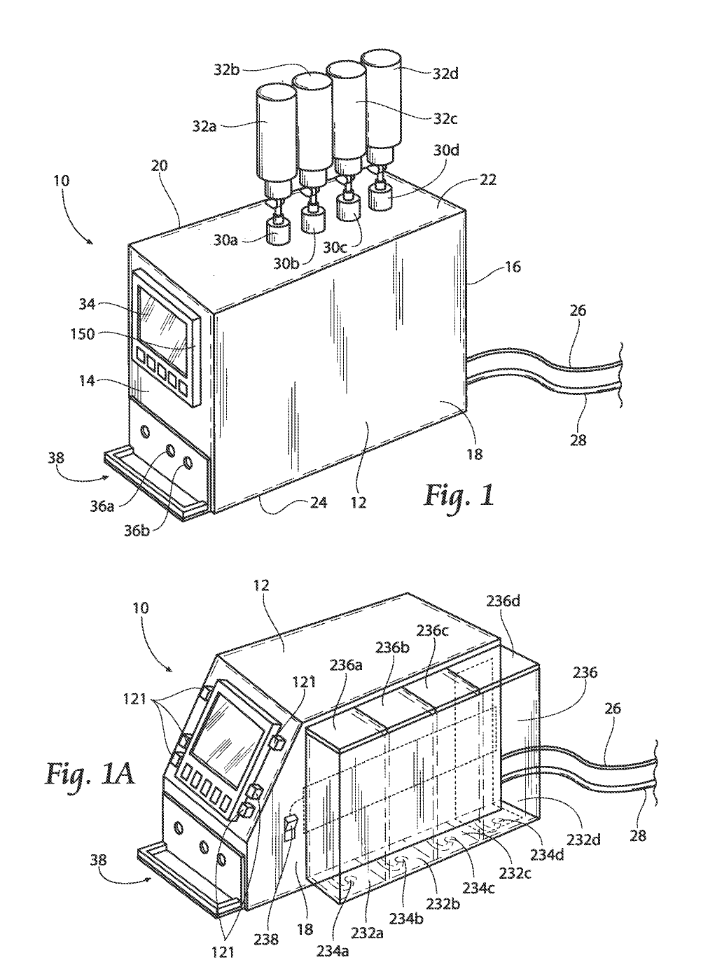

FIG. 1 provides a programmable dental device 10 according to the present invention. The device 10 generally comprises a housing 12 having a front 14, a back 16, and two opposing sides 18, 20. The housing 12 also has a top 22 and a bottom 24. The housing 12 is shown as being rectangular in shape, but could be of any shape and arrangement as desired. The device 10 has an electrical connection 26 and a vacuum connection 28, preferably located on the back 16, but which could be located at any position on the housing 12.

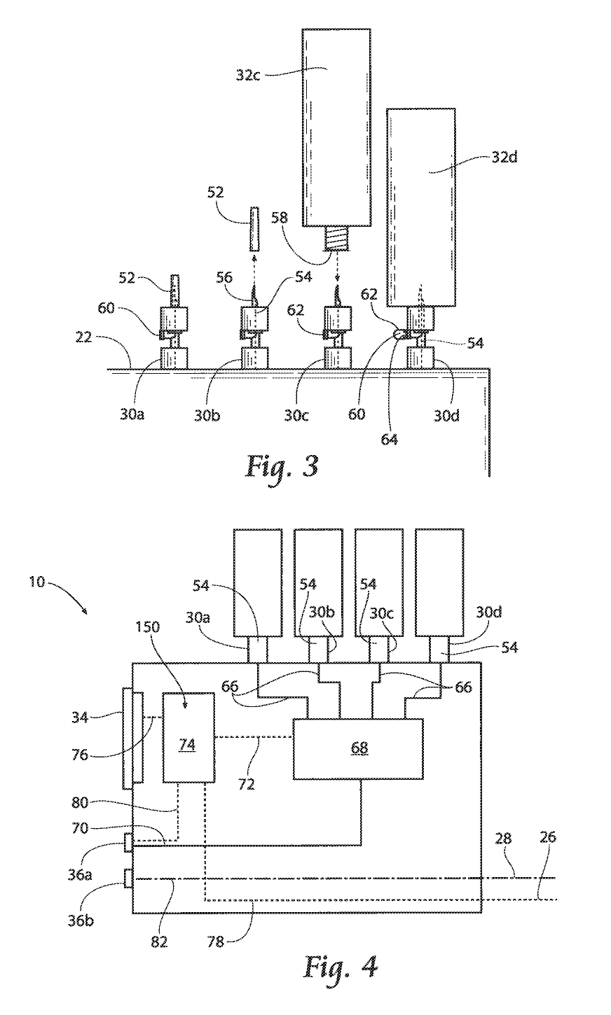

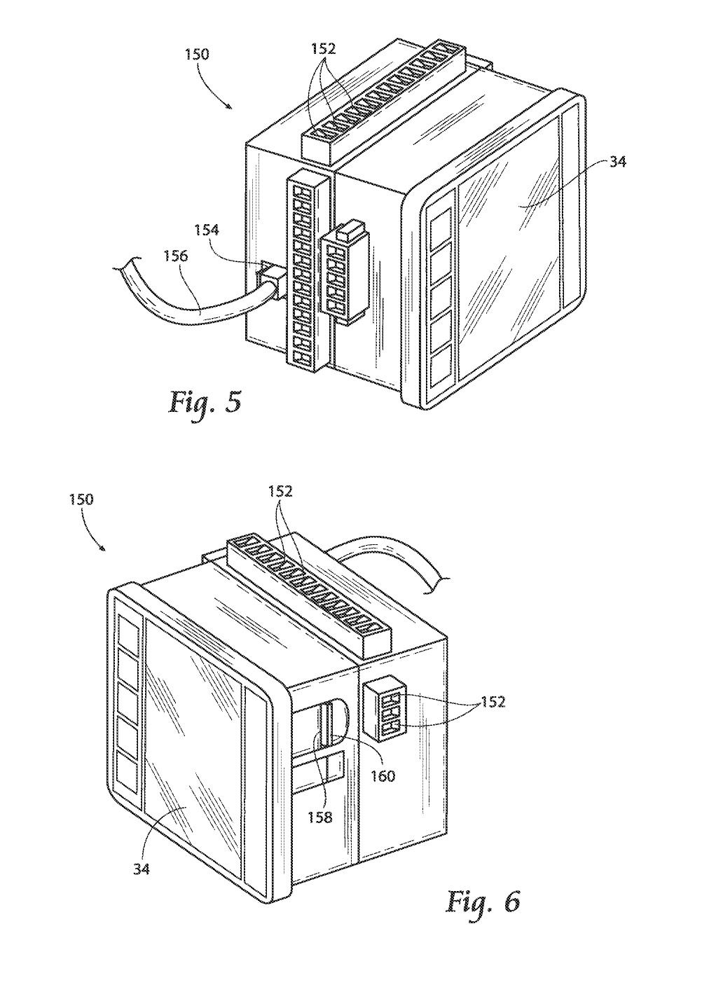

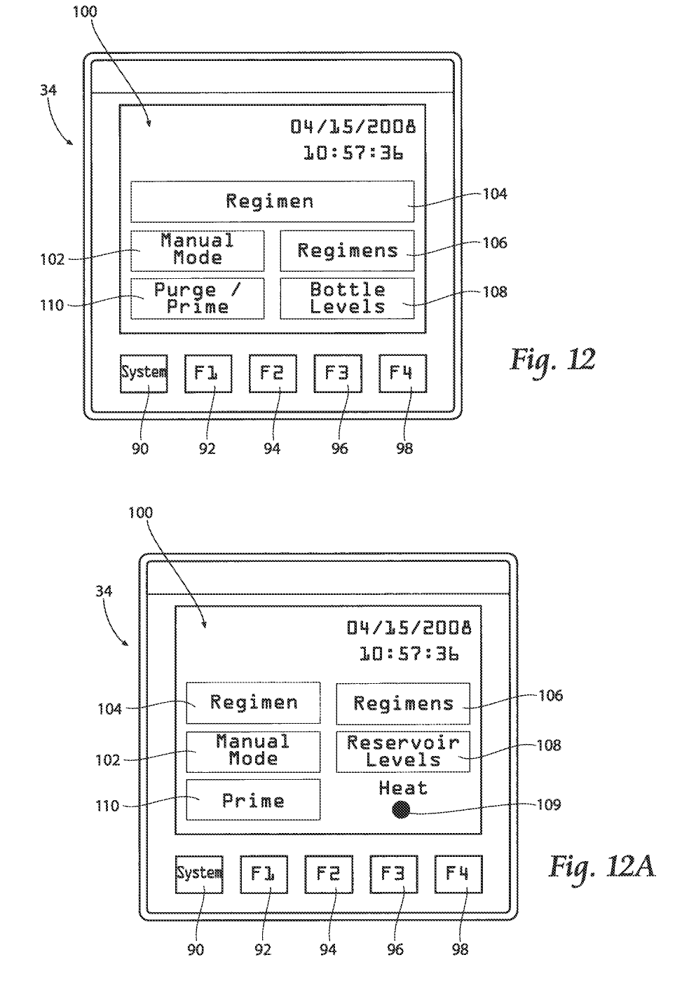

Still referring to FIG. 1, the top 22 supports a plurality of fluid ports 30a-30d, which support a plurality of respective fluid containers 32a-32d. The ports and the containers will be discussed more with respect to FIG. 3. It is understood that more or fewer ports and containers can be supported by the housing 12 and the ports and containers could be located on a different position on the housing 12, such as having the ports and containers located on the back 16. The housing 12 also supports a control screen 34, preferably located on the front 14 of the housing 12, which provides an interface for a programmable control device 150 for the device 10. The programmable control device will be discussed further with respect to FIGS. 5 and 6. The various functions of the control screen 34 will be discussed in detail with respect to FIGS. 12-22. Likewise, a plurality of buttons used to operate the device 10 are located on the front 14 of the housing, and will be discussed in more detail with respect to FIGS. 12-22. The front 14 also supports a pair of portals 36a, 36b, of which there could be more or fewer portals, used to connect various dental instruments to the device 10. A tray 38, preferably removable, is attached to the housing 12 to provide a fluid collection area when attaching or detaching instruments when operating the dental device 10.

FIG. 1A provides a perspective view of an alternate arrangement of the dental device 10. The fluid containers 32a-32d have been replaced by a fluid container 230 located on the side 18 of the housing 12. The container 230 comprises for separate compartments 232a-232d, which correspond to the containers 32a-32d shown in FIG. 1. Each of the compartments 232a-232d has a corresponding port 234a-234d, which will allow fluid from the compartments 232a-232d to be in fluid communication with the fluid system of the device 10, which will be described in further detail below. The compartments 232a-232d each have a respective lid 236a-236d for sealing the compartments 232a-232d. It is possible that one lid may be used to cover all of the compartments 232a-232d, but separate lids are preferable to limit possible mixing of the various fluids. Also, each of the lids 236a-236d may have an opening (not shown) located on the lid 236a-236d, wherein a fluid container, such as one of the containers 32a-32d shown in FIG. 1, could be inserted into the opening to minimize splashing or mixing of fluids.

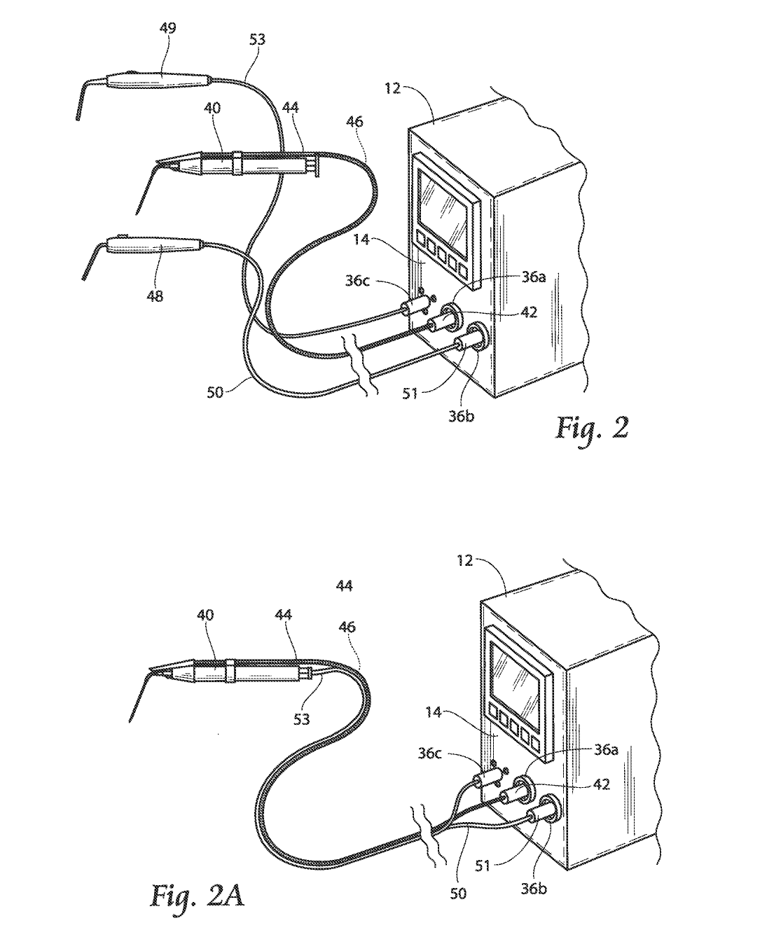

Referring once again to the device 10 as depicted in FIG. 1, FIG. 2 shows a partial perspective view of the front 14 of the housing 12. As stated, the front 14 supports portals 36a, 36b, which allow the device 10 to be connected to dental instruments. As an example, portal 36a allows connection to an ultrasonic vibratory dental instrument 40 by way of a connector 42 that can be inserted into the portal 36a. The dental instrument 40 has a fluid passageway 44, which also houses a wire 46 that provides energy for the instrument 40. As will be evident from FIG. 4, the instrument 40, or any other instrument used, will be connected in such a manner so that it can selectively be used with one or more of the fluid containers 32a-32d. A second dental instrument 48 has a fluid passageway 50 and also is connected to the portal 36b by way of a connector 51. The second instrument 48 is demonstrated as providing delivery of a second fluid, with the portal 36b being also being in communication with the fluid system of the device 10, as was the portal 36a. It is understood that any type of instrument could be used, and the instrument could be connected to the fluid containers 32a-32d, as was the instrument 40. For example, there may be certain solutions used within the system that should not be mixed with each other, and separate instruments would be advantageous in such situations.

Still referring to FIG. 2, a third dental instrument 51 is shown attached to the device 10. The instrument 51 has a fluid pathway 53 that connects the instrument 51 to a port 36c, which is preferably in fluid communication with vacuum connection 28 (see FIG. 1). The attachment of the instrument 51 to the device 10 further exemplifies the novelty of the present invention, which allows for multiple dental instruments to be located and controllable from the same programmable device 10. Further, the attachable instruments can be varying types, such as scaler, ultrasonic device, irrigators, aspirators, etc., and the present device 10 provides the capability to properly operate each of these devices. The device 10 also has programming capabilities so that both evacuation and irrigation can be performed simultaneously.

FIG. 2A provides an alternate connection arrangement of the dental instruments shown in FIG. 2. Instead of having individual dental instruments connected to each of the ports 36a-36c, the dental instrument 40 is connected to all three of the ports 36a-36c by way of fluid lines 46, 50, and 53, as the individual instruments were in FIG. 2. The arrangement allows for multiple functions to be carried out by a single handpiece, such as irrigation, evacuation, and the delivery of ultrasonic energy. It should be understood that the device 10 is capable of providing programming and controlling dental instruments as shown in either FIG. 2 or FIG. 2A, or as a combination of the two. That is, the device 10 is capable of providing programming for multiple dental instruments, with each of the instruments connected to varying numbers of fluid ports. For example, the irrigating dental device described in co-pending application, U.S. Ser. No. 11/728,821, which is incorporated by reference, is directed towards an irrigating and evacuation handpiece having a flexible needle that can also deliver energy to the dental needle. The present device 10 is capable of programming and controlling such an instrument.

FIG. 3 provides an elevation view of the containers 32a-32d and the fluid ports 30a-30d located on the top 22 in various stages of mating with one another. Like numbers refer to like elements. The containers 32a-32d preferably are standard sized containers, as well as the ports providing standard connection systems. The containers and ports may also be color coded or key coded to minimize mixing of certain fluids that should be kept separate from one another.

Still referring to FIG. 3, port 30a is shown without being attached to a container. A cover 52 is located within the port 30a, as a protective device. Each of the ports 30a-30d has a cover 52 located on a respective port when that port is not being used, and each of the covers will be referred to with reference numeral 52. The cover 52 is removed from the port 30b, which exposes a hollow passageway 54 and a jag 56 located at the end of the passageway 54. Container 32c is shown being positioned over port 30c, with fluid being retained within the container 32c by a seal, preferably a foil seal 58. As demonstrated by the container 32d and the port 30d, the container 32d is mated with the port 30d, thereby having the seal 58 pierced by the jag 56, allowing fluid to flow from the container 32d through the passageway 54. Each of the ports 30a-30d also has a damper or air vent 60, that assists in fluid flowing smoothly from the containers 32a-32d through the passageways. The air vents 60 can be selectively opened or closed with a cover 62. A filter 64 is located within the air vent 60 to prevent fluid passing through the passageway 54 from becoming contaminated with particles in the air when the air vent 60 is open.

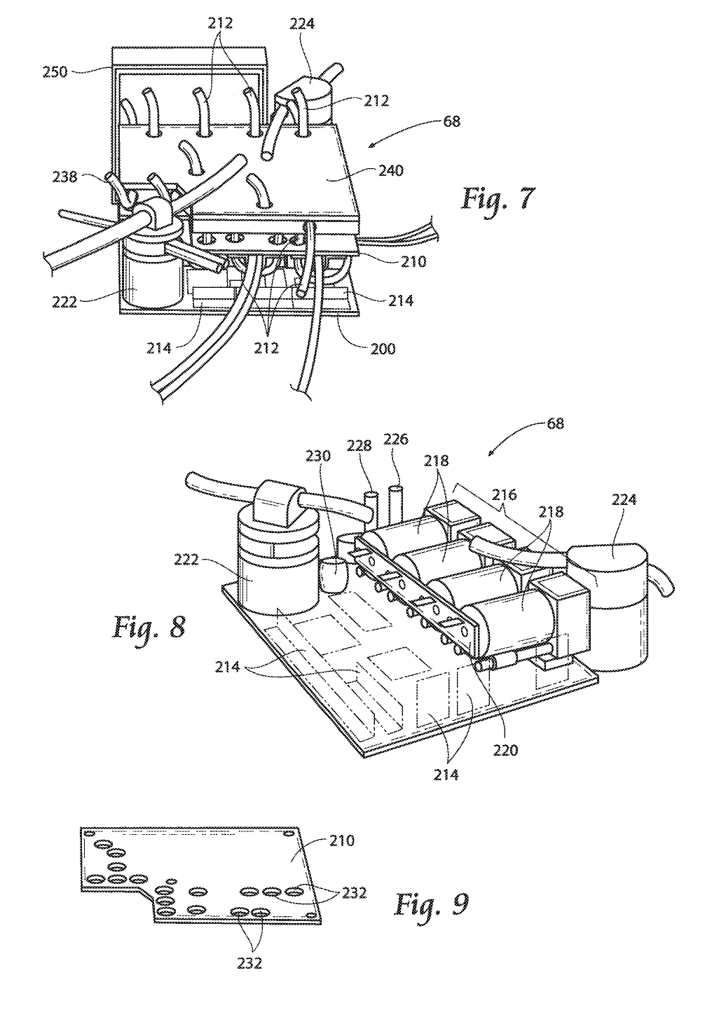

FIG. 4 provides a schematic view of the device 10 and a possible arrangement or a design for the device 10 to generally operate. As discussed in FIG. 3, each of the ports 30a-30d has a fluid passageway 54, which in turn is connected to a respective tubing section 66. It should be noted that an arrangement as shown in FIG. 1A would have a similar design, with the ports 234a-234d connected to the respective tubing section in place of the ports 30a-30d. Each of the tubing sections 66 is routed to or through a pumping control system 68, which allows a selective fluid to flow from one of the containers 32a-32d to fluid line 70 and out to port 36a. The pumping control system 68 will be described in further detail with respect to FIGS. 7-11. The control system 68 is connected to a power line 72, which is connected to the program control device 150, which is preferably a programmable logic controller (PLC), which provides the necessary information for selecting one of the fluids for delivery. The use of a PLC also allows more than one pumping regime to be operated by the device 10 simultaneously. The pumping control system 68 can include an automatic shut-off if necessary, to address such issues like clogged lines. The PLC 74 is electrically connected to the control screen 34, either integrally connected to the control screen 34 or with an electrical connector. For demonstration purposes, the PLC is shown connected to the control screen 34 by a line 76 to the control screen 34, with the control screen 34 providing an area for a user to enter various information and commands for the control device 150. The control device 150 can be powered by any means but is preferably connected to the electrical connector 26 by way of an electrical line 78 to the electronic connector 26.

A line 80 is also connected to the portal 36a and to the connector 26, thereby providing the necessary power so that a dental instrument, such as the ultrasonic instrument 38, will receive the necessary power to operate properly. As shown in FIG. 4, the portal 36b is connected to the vacuum connection 28 by way of a fluid pathway 82. It is possible that the portal 36b may also be directly connected to the fluid line 70 and/or another fluid pathway could be connected to the containers 32a-32d. Likewise, the portal 36a could be in communication with the vacuum connection, if desired. The arrangement of FIG. 4 is only one possible arrangement that would fall within the scope of an irrigator according to the present invention. Provided that a programmable dental device has the capability to selectively provide multiple fluids to one or more dental instruments, the device would fall within the scope of the present invention. For example, there could be an individual pump 68 associated with each fluid container 32a-32d and each separate fluid pathway 54. In the case where there is an individual pump for each fluid container, preferably there would be an automatic override switch for each container, and also preferably a manual on/off switch for each container.

FIGS. 5 and 6 provide perspective views of the programmable control device 150, which will provide the necessary controls for properly routing and controlling the flow of fluids through the device 10. As previously stated, the control screen 34 is located on the control device 150 to allow an interface for the user to program the device 150. The device 150 has a plurality of electrical connections 152 that will allow the device to be connected to the pumping control system 68. The device 150 has a port 154 for receiving a cable modem 156 or similar device, such as an Ethernet connection, that would allow the device 150 to transmit, download or receive information from a remote source, such as the internet. FIG. 6 further shows the device 150 supporting a data drive 158 that is designed to receive a memory card 160, which will allow the device 150 and the device 10 to access other stored information. Overall, the device 150 is designed so that there are several various processes and methods that can be employed to operate the irrigator and control the pumping control system 68. The device 150 is capable of transmitting information by way of an RF transmitter, a fiber optical connection, or other various wired and wireless processes.

FIG. 7 provides a perspective view of the pumping control system 68. The pumping control system 68 provides a compact and unique arrangement. The control system 68 generally comprises a plurality of layers that will allow the various control lines and fluid lines to be organized in a small, compact area and to be routed within the irrigator in a concise, efficient process. A circuit board 200 provides a first layer for the pumping control system 68. A fluid routing layer 210 is upwardly space apart from the circuit board 200 and provides a framework for various fluid lines 212 to be routed for the device 10.

The fluid lines 212 generally refer to all of possible fluid lines within the system, such as tubing section 66, fluid line 70, and the fluid pathway 82, as discussed with respect to FIG. 4, and other fluid lines and pathways previously discussed in the application. The pumping control system 68 further comprises an upper portion 240, which provides a further routing arrangement for the various fluid lines 212.

FIG. 8 provides a perspective view of the circuit board 200. The circuit board 200 supports various electronic components 214, such as transistors, diodes, resistors and other commonly known electronic components. A control pump 216 comprised of a plurality of individual pumps 218 is used to deliver and route various combinations of fluids passing through the device 10. A motor control 220 is electrically connected to the pumps 218 for operation of the pumps 218. A pinch valve 222 is also supported by the circuit board 200. The pinch valve 222 acts as an on/off mechanism used with the pumping system 68. As fluids pass through the various fluid lines 212 and are routed through the pumping system 68, the routed fluids may pass through the pinch valve 222. A second pinch valve 224 may also be used to provide an/off for the vacuum system 68. The two pinch valves 222, 224 could be employed in series, in parallel, or may be used separately for specific fluid lines.

Still referring to FIG. 8, the pumping system 68 comprises other elements that are utilized to control proper flow of fluid through the device 10. For example, a fluid tube 226 is situated next to a pressure sensor 228 to regulate the proper fluid pressure passing through the system 68. A magnetic floater 230, preferably a ferrite floater, is also used to assist fluid flow through the system 68. Optical fluid level sensors are also used to assist fluid flow through the system 68.

FIG. 9 depicts the fluid routing layer 210 of the pumping system 68. The layer 210 is preferably a solid, planar material, likely a solid plastic material. The layer 210 has plurality of openings 232 located throughout that are used to direct the fluid lines 212 through the pumping system 68 and the upper portion 240 (see FIG. 7) to direct the fluid lines 212 to the necessary areas throughout the device 10. The layer 210 is constructed to contain fluid check valves where needed to prevent fluid backflow.

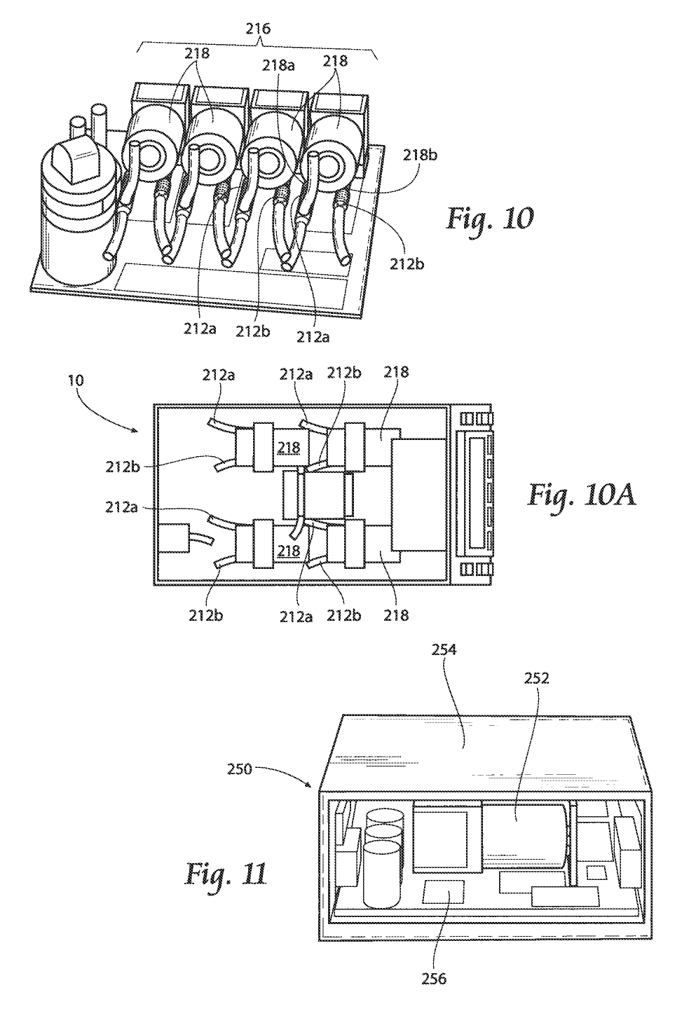

FIG. 10 is a front perspective view of the control pump 216 situated on the circuit board 200. Each of the individual pumps 218 are intended to control the flow of fluid from one of the individual reservoirs described with respect to FIG. 4. Generally speaking, an intake fluid line 212a and an out flow fluid line 212b are connected to a respective inlet 218a and outlet 218b on each of the individual pumps 218. The fluid lines 212a, 212b are fitted on the inlets 218a and outlets 218b in a fluid tight manner.

The fluid lines 212a, 212b are routed to/from the pumps 218 with the assistance of the routing layer 210 and the upper portion 240, which provide a simple, efficient way of routing the various fluid lines 212 through the device 10.

FIG. 10A provides an overhead view of the individual pumps 218 arranged in an alternate fashion as that shown in FIG. 10, with the pinch valve 222 located centrally of the individual pumps. FIG. 10A is shown merely to show that the positioning of the individual elements within the pumping system 68 can be rearranged and still fall within the scope of the present invention.

FIG. 11 provides a perspective view of the drive motor system 250 for the pump system 68. The drive motor system 250 comprises a motor 252 located within a housing 254, which is preferably a black box style housing that provides protection for the motor or motors 252 and the overall system against possible temperature and liquid damage. A circuit board 256 is also located within the housing 254, with the circuit board 256 being used to convey information to/from the motor 252 and the pumping system 68.

The motors 252 are preferably mounted on the circuit board 256, as seen in FIG. 10.

The motor system 250 may also provide means for regulating fluids as they flow through the pump system 68. While performing root canal procedures, heating the fluids in the device 10 may allow for increased medicinal reaction rates and increased medicinal antimicrobial activity for the fluids. Temperature regulation for the various fluids in the system could be performed manually with individual heating elements being associated with each of the fluid containers 32a-32d or compartments 232a-232d, or it could be an automatic, programmable feature for the device 10. An example of a heating element 238 is shown in FIG. 1A.

FIGS. 12-22 demonstrate various functions that can be performed with the irrigator of the present invention. The display control screen 34 is shown, with various commands and functions represented on the screens. As previously discussed, the irrigator provides a variety of functions that can be programmed by the user while carrying out a dental procedure, or can be preprogrammed for various procedures. The control screen 34 is preferably a touch screen, whereby the user presses the various buttons and displays on the screen to control or direct the irrigator.

FIG. 12 shows the control touch screen 34 displaying a start-up display 100. The display 100 of the screen 34 may display the time and date, and provide for various options such as whether a manual mode 102 should be selected or whether a preprogrammed regimen 104 should be selected. The screen 34 may also display the current or previous regimen selected 106, and controls, such as the fluid level 108 with any of the containers 32a-32d or whether any of the fluid lines should be purged or primed 110. The screen 34 may have a few standard control buttons, such as a system self test button 90 for running through the functions of the device 10 to determine whether the device 10 is functioning properly, and four shortcut keys 92, 94, 96, 98, shown as F1-F4, respectively, that can allow the user to skip forward to a predetermined display or regimen of the irrigator. Other short keys 121, which are shown in FIG. 1A, can be used to access preset steps of the device 10, or possibly access a previously run regimen.

FIG. 12A shows a similar start-up display 100′ as that shown in FIG. 12A, with the addition of a heat control 109. FIG. 12A further demonstrates the adaptability of the present device 10 to have multiple control features previously not demonstrated or shown within an individual programmable dental device. That is, the programmable features of the present invention, which include various fluid delivery regimens, the addition of energy to the regimens, and the simultaneous programmability of various dissimilar dental instruments within an individual portable device has not been previously attained.

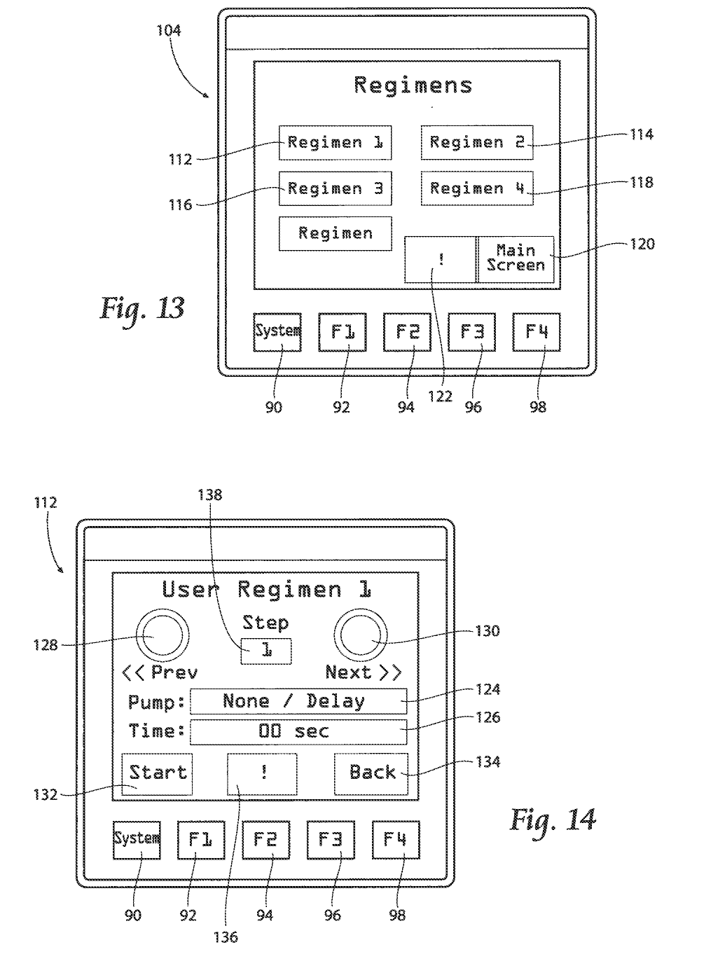

In FIG. 13, the user selected the Regimen 104 control from FIG. 12. The Regimen screen 104 displays four buttons for the user to choose from, regimen 1, regimen 2, regimen 3, and regimen 4, referred to as reference numerals 112, 114, 116, and 118, respectively. More or fewer regimens could be programmed into the system as desired. The Regimen screen 104 also has options where the user can go back to the main screen 120, or go to a help screen that may instruct the user on questions, such as potential problems or issues of various solutions used during any specific procedure.

In FIG. 14, the user selected button 112, Regimen 1, which shows a first step for Regimen 1. The display shows which pump is to be used (124) and for how long of a duration (126). That is, the display shows which of the containers 32a-32d fluid will be used for a specific step of Regimen 1. As shown, fluid is not being accessed from any of the containers 32a-32d in step 1, but the vacuum is running. Regimen 1, which is exemplary of other regimens that could be run according to the present invention, allows the user to verify each of the steps of the regimen before running the regimen. For example, screen 112 provides buttons for going to a previous step 128 or next step 130 in the regimen, a start button 132, a button 134 that will allow the user to go back to the previous screen (FIG. 13) and select a different regimen, and also a help button 136.

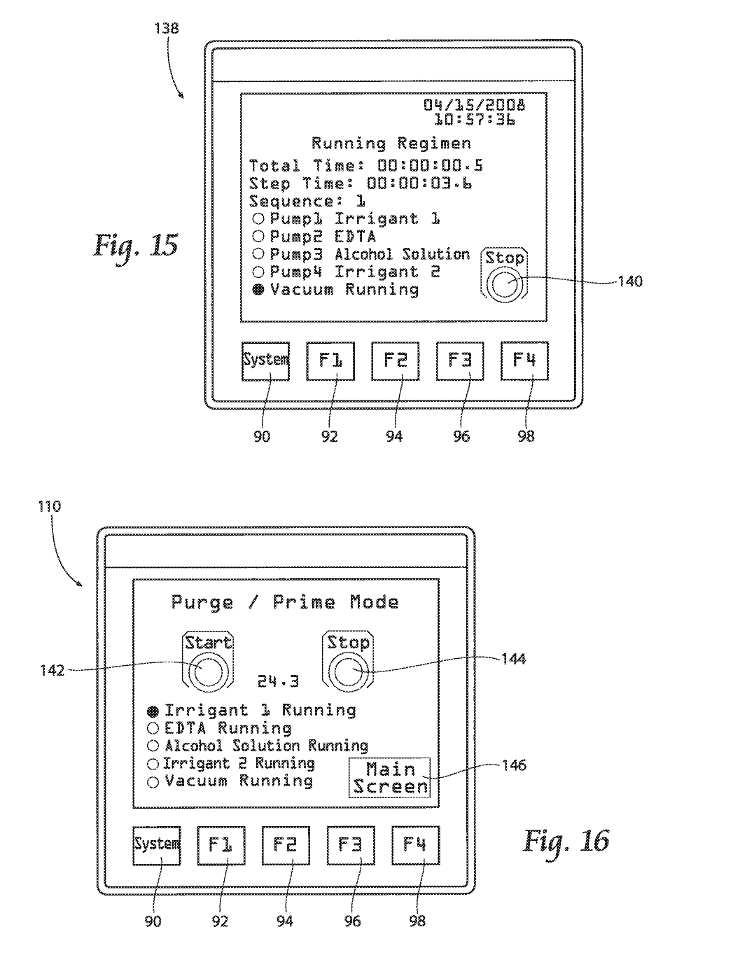

The user can select the step button 138, which will direct the user to the screen shown in FIG. 15.

FIG. 15 provides further details on Step 1, verifying that the vacuum is indeed running and that none of the pumps are running. That is, FIG. 15 shows that fluid is not currently being delivered from any of the containers 32a-32d, with each of the containers being represented or shown by a respective pump. FIG. 15 also shows how long step 1 will be running and provides a stop button 140 to terminate the step.

FIG. 16 demonstrates a further step of a Regimen, showing that an irrigant is being used in the system. In this particular step, the user has selected the Purge/Prime mode 110 (see FIG. 12) to clean and flush the system. A start button 142 and a stop button 144 allow the user to run a specific solution for a desired time. As an example, the irrigant could be a hypochlorite solution, EDTA, a chlorhexidine solution, an alcohol solution, MTAD, citric acid, or other commonly used solutions, and could be housed in any of the containers 32a-32d. FIG. 16 also shows how much time has elapsed for the step and provides a button 146 that will allow the user to transfer back to the main screen (FIG. 12) for selection of another regimen if necessary or desired.

A regimen could be selected having a variety of steps and solutions entered for a specific regimen. For example, each of the solutions depicted in FIG. 8 could be used for varying amounts of times, including one or more step of the vacuum running. The number of steps being stored for an individual regimen is not limited to any specific number of steps, with any of the steps not limited to any specific length of time.

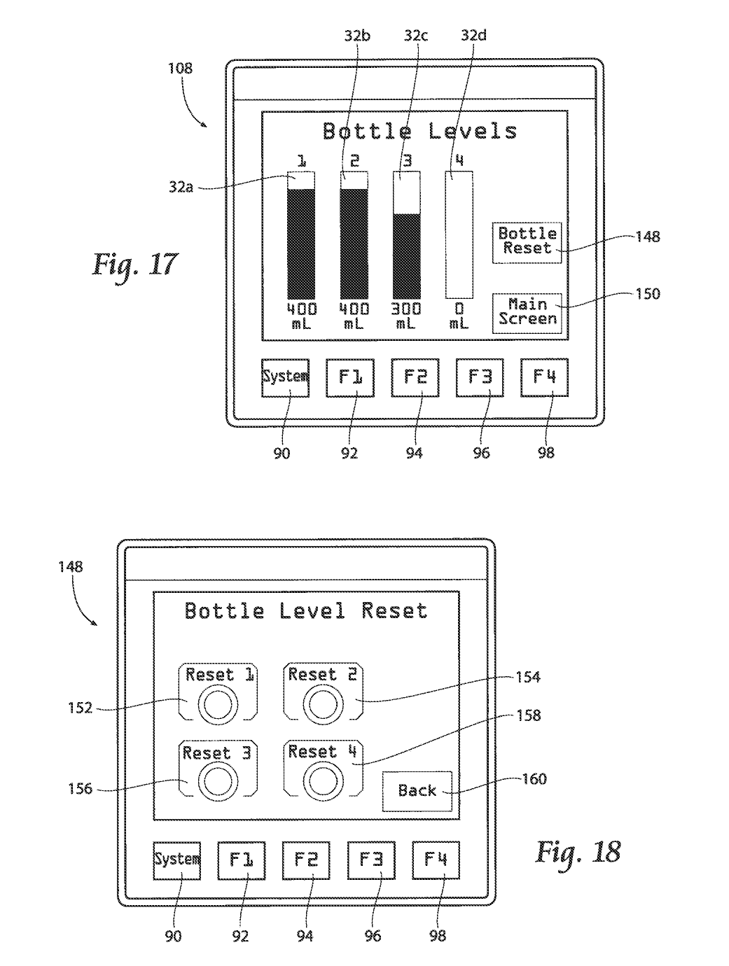

Besides being capable of monitoring various irrigation programs and regimens, the irrigator of the present invention also is capable of monitoring the various fluids and fluid levels used in connection with the irrigator. FIG. 10 shows the bottle levels screen 108 (see FIG. 12) with a diagrammatical representation of the four containers 32a-32d, and the amount of fluid left within each container. As shown, bottle #4 (i.e. container 32d) is empty, indicating to the user that a new container or bottle should replace the empty container. A new container can be replaced on the device 10, as shown and described with respect to FIG. 3. The user will then be able to reset the PLC to state that a full bottle has been replaced, by pressing the Bottle Reset button 148, which will take you to the screen shown in FIG. 11, which allows the user to reset one of the four bottles by pressing a reset button, 152, 154, 156, or 158, in this case bottle #4 (container 32d) by pressing the Reset 4 button 158. The user could reset more than one bottle from the screen shown in FIG. 18. The user may then press the Back button 160 to go back to the screen shown in FIG. 17, and then pressing the Main Screen button 150 in FIG. 17 to get back to the main screen shown in FIG. 12. It should be noted that it is not necessary that the container volumes are calculated in this manner, as there could be sensors located directly within fluid flow lines or within the container. However, calculating the container volume in this fashion minimizes contact of the sensors with any caustic fluids that may be used with the irrigator, thereby minimizing corrosion of the sensors. Alternatively, optical sensors may be used to determine the container volumes.

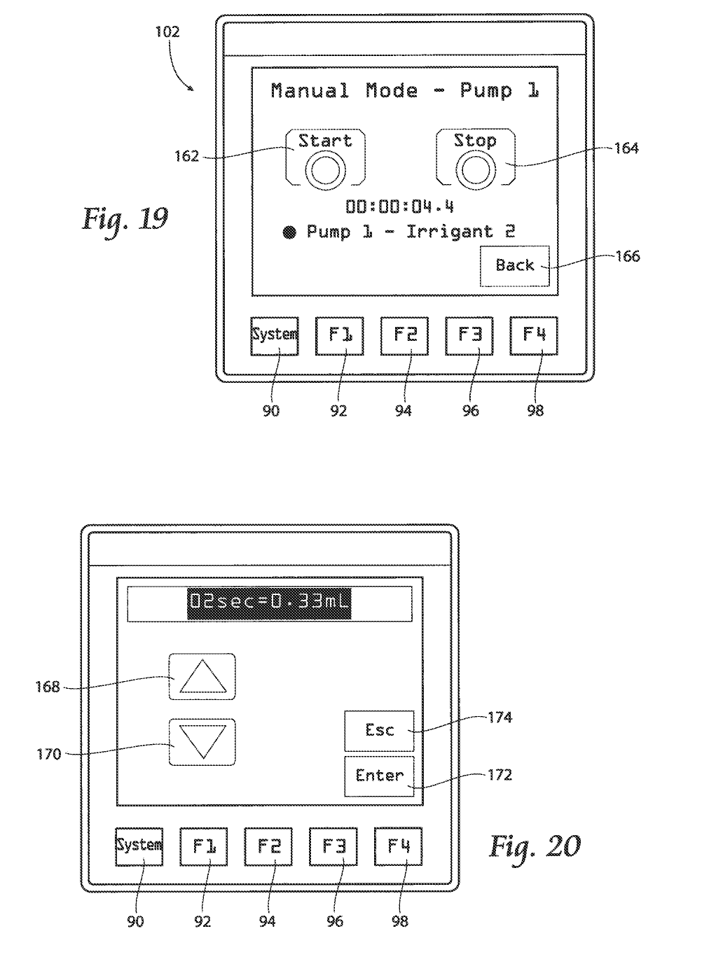

As previously discussed, the present invention allows a user to manually operate and run the device 10 as necessary. In FIG. 12, the user may select the Manual Mode 102, which would allow the user to select which pump and which container of fluid to be used for a particular procedure. As shown in FIG. 19, the user has selected Pump 1, which would be connected to bottle 1 (container 32a) that contains an irrigant. The screen of FIG. 12 has a start button 162 and a stop button 164 to commence or end the manual cycle. The screen also displays how long the specific cycle has been running. Once the user has determined that the cycle has run for a sufficient time, the user can hit the Back button 166 to either select another pump to deliver a fluid or exit backwards to the main screen.

Fluids used during dental procedures generally are measured as volumes used (i.e. mLs) and are not generally measured as to the length of time that the fluid has been used. For instance, it may be determined that it is preferable to use a specific amount of an irrigant (i.e. 50 mL of a hypochlorite wash solution) during a procedure. The irrigator of the present invention provides a function screen, as shown in FIG. 13, that allows the user to determine how much fluid will delivered during a specific stage by entering how long the cycle will run. That is, the irrigator can be programmed to convert the time entered into the amount of fluid passing through the system, since it is preferable that the containers, connections, and fluid lines are of a standard size and diameter commonly used in the dental industry. As shown in FIG. 20, the conversion screen shows that 0.33 mL of solution corresponds to a run time of 2 second. The conversion screen has up 168 and down 170 buttons, which allows the user to increase or decrease the time/fluid amount being used within a specific step. The user may press the enter button 172 when desired amount is reached, or erase the entered amount by hitting the escape button 174. Depending on the fluid that is within each of the specific containers, the irrigator can be programmed to account for differences in viscosity of the individual fluid. For example, the irrigator may be corrected or recalibrated for a specific container containing a specific fluid to show that less fluid will flow over a given time if that fluid is very viscous. Generally, however, the majority of fluids used in irrigation processes can be considered as having the same viscosity, thereby not requiring any calibration or correction when using one fluid to the next.

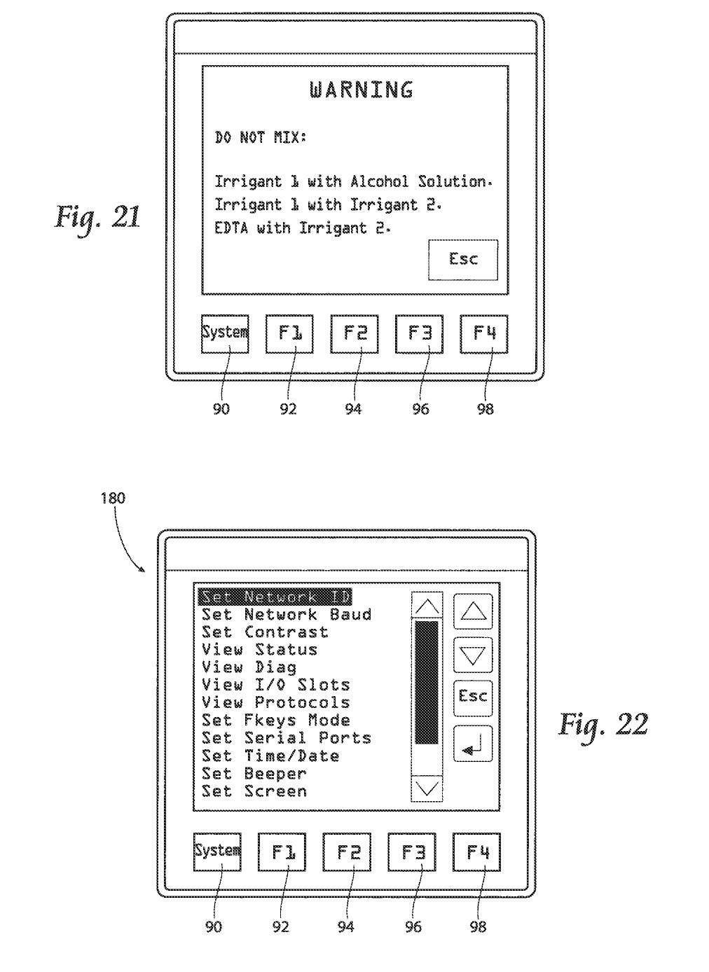

As noted when discussing FIG. 21, the screen 34 may display a help or warning button 122 that can alert the user in certain situations, such as warning against mixing of specific fluids within the system, or whether a fluid container may be empty. FIG. 21 shows such a warning screen. The warning screen displays which of the fluids within the irrigation system should not be mixed with one another. For example, the warning screen shows that the first irrigant from the container 32a should not be mixed with the alcohol solution housed in the container 32c or with the second irrigant housed in the container 32d, while the EDTA solution housed in the container 32b should not be mixed with the second irrigant housed within the container 32d, which can assist the user when the feed line to one of the dental instruments must be purged. The warning screen assists a user in properly carrying out a regimen, especially when carrying out a manually operated regimen.

The device 10 can be programmed and personalized for an individual user. FIG. 22 demonstrates a further control screen 180 with various features of the device 10 that can be programmed by an individual user. These features include a wide range of features, such as setting the time and date of the system, setting alerts and warnings for the system, arranging the ports to receive various dental instruments, and other various features. The device 10 is also capable of interfacing with an external computer, the internet, or another server or interface option that will allow the device 10 download and/or store information pertaining to a specific fluid being used in the system, to a specific patient, or possibly to a specific procedure. For example, when a new fluid is introduced into the device 10, the user may be able to access information from an external source to determine whether any of the other fluids within the device 10 may have adverse effects if mixed within the new fluid. Also, a specific patient's pertinent dental history may be downloaded to the irrigator from an external source so that a particular procedure will be carried out properly, including potential allergies and the like that the patient may have. The specific patient's information can be stored and transmitted with the control device 150, described with respect to FIGS. 5 and 6. Recordation and storage of patient's information is also advantageous in providing accurate clinical charting.

The present invention provides a greatly improved dental apparatus compared to the prior art devices. The device 10 provides a compact and efficient device that can store, transmit, and receive a wide range of data, which allows a user to carry out a wide range of processes with the device 10. Moreover, the device 10 incorporates an new, efficient fluid control system not previously present in prior art systems. The present invention allows for the fluid lines, circuit board, pumps, and motors to be compactly located within the device 10, while minimizing or preventing undesired interactions between the various components. That is, the fluid lines and pumps are located close to the circuit board without fear that the fluids will short the circuit board. This was not realized prior to the present invention, as the design of the fluid control system was not realized prior to the present invention.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I/We claim:

1. A programmable dental device for delivering fluid from a plurality of self-contained fluid containers to a plurality of dental instruments, said programmable dental device comprising:
a housing having a plurality of fluid ports;
a plurality of self-contained fluid containers removably coupled to and configured to be in fluid communication with the plurality of fluid ports;
a display control screen, said display control screen comprises a touch screen;
at least one fluid outlet located on said housing, said at least one fluid outlet configured for fluid communication with said fluid ports, said at least one fluid outlet providing means for dental instruments to be fluidly attached to said programmable dental device;
a vacuum outlet located on said programmable device, said vacuum outlet in communication with a vacuum source;
a fluid control system located within said housing for routing said fluids through said programmable dental device, said fluid control system configured for fluid communication with said at least one self-contained fluid container and said fluid outlet, said fluid control system comprising:
a circuit board;
a plurality of pumps mounted on said circuit board and individually connected to a respective one of said at least one self-contained fluid container;
a motor connected to said pumps;
a plurality of fluid lines connecting said pumps to said fluid containers; and
a plurality of fluid lines connecting said pumps to said fluid outlet; and
a programmable control device supported by housing, said programmable control device configured to interact with said fluid control system to selectively deliver fluid from one of said fluid containers through said control system to said fluid outlet, said programmable control device further comprising means for monitoring the fluid levels in said plurality of containers, said programmable control device configured to store a plurality of preprogrammed multi-step regimens for delivering said fluids from said fluid containers to said fluid outlet at predetermined steps;
wherein said programmable controller is configured to recognize a particular dental instrument attached to a particular one of said at least one fluid outlet.

2. The programmable dental device according to claim 1 wherein said fluid control system further comprises:
a fluid routing device spaced apart from said base structure, said routing device having a plurality of openings, said fluid lines being directed through said openings.

3. The programmable dental device according to claim 1 further providing means for heating and regulating the temperature of said fluids.

4. The programmable dental device according to claim 1 wherein said programmable control device further comprises means for receiving and transmitting information from a remote source.

5. The programmable dental device according to claim 4 wherein said means for receiving information is selected from the group consisting of: a port for receiving a cable modem, a RF transmitter, a fiber optical connection, an Ethernet connection, or combinations thereof.

6. The programmable dental device according to claim 1 wherein said programmable control device further comprises a data drive.

7. The programmable dental device according to claim 1 further comprising means for heating fluid within said device.

8. The programmable dental device according to claim 1 wherein said programmable dental device is configured to deliver ultrasonic energy to at least one of said dental instruments, said ultrasonic energy being delivered simultaneously with the delivery of one of said preprogrammed regimens.
